(19) United States
(12) Patent Application Publication
(10) Pub. No.: US 2008/0257824 A1
(43) Pub. Date: Oct. 23, 2008

(54) Method and Apparatus for Water Purification and Regeneration of Micro-filtration Tubules

(75) Inventors: Benjamin Anthony Campanile, Petaluma, CA (US); James Anthony Pagliaro, Santa Rosa, CA (US)

Correspondence Address: EDWARD S. SHERMAN, ESQ., 3554 ROUND BARN BLVD., SUITE 303, SANTA ROSA, CA, 95403, US

(73) Assignee: SQUARE PEG ENGINEERING, LLC, Santa Rosa, CA (US)

(21) Appl. No.: 12/107,481

(22) Filed: Apr. 22, 2008

Related U.S. Application Data
(60) Provisional application No. 60/913,522, filed on Apr. 23, 2007.

(51) Int. Cl. C02F 1/42; B01D 24/46

(52) U.S. Cl. 210/673; 210/108

(57) ABSTRACT

A method of water purification by submicron filtration deploys a 6-way valve to periodically flush or clean the tubules in a predetermined selection of cleaning steps, some of which optionally introduce and then flush out chemical cleaning agents. The tubules are cleaned without disassembly of the filtration cartridge.

### CROSS REFERENCE TO RELATED APPLICATIONS

The present application claims priority to the US provisional patent application of the same title, filed on Apr. 23, 2007, having Application. Ser. No. 60/913,522, which is incorporated herein by reference.

### BACKGROUND OF INVENTION

The present invention relates to water purification by micro-filtration, and more specifically to a method of cleaning and using a micro-filtration system.

When water is purified by micro-filtration it is pumped through a semi-porous membrane that has filter pore sizes small enough to block particulate mater that includes bacteria, yet permits water to pass through. A common configuration for such membranes is in the form of fibers or tubules that are hollow and have porous walls. Such tubules are assembled into bundles with a portion of the intervening space between them sealed at a top and bottom portion to form a common chamber. Typically this assembly is organized concentrically about a much larger hollow center tube with macro-perforations in the walls and packages in a cylindrical cartridge. In one configuration termed, “inside-to-outside” flow, water to be purified enters the tubules from above the upper seal at the top of the cartridge such that pure water then flows into the center tube, with the contaminants trapped inside the tubules. Alternatively, water can be pumped through the central tube against the outside of the tubes such that and the clean water is collected from inside the tubules after it flows into the portion of the cartridge above the upper seal, which is termed “outside-to-inside” flow. The flow type is usually specified by the cartridge manufacturer and can be dependent on the specific membrane configuration. The use of the term cartridge refers to both the exterior pressure vessel that contains fluid as well as the tubule array within, although the latter is frequently sold as a separate unit that interchanges in different pressure vessels.

Eventually such micro-filtration systems become fouled when contaminants fill or plug the pores in the tubules and the tubules resist the flow of water there through. Prior methods of cleaning fouled micro-filtration cartridges involve using the flow of water along the tubules, on either the inside (for inside-to-outside” flow) or the outside (for “outside-to-inside” flow) to remove particulate to flush or hydro-dynamically push the particulate of the same side of the filter elements. Frequently some combination of a chemical attack of the fouling matter or particulate is used, which usually requires removal of the filter cartridge.

Removing the filter for such cleaning is labor intensive, time consuming and requires the installation of either spare cartridges or a back up system. Fouling generally limits the use of micro-filtration to water that is already relatively consistently generally free of particulate.

It would also be desirable to have a more effective means to clean fouling matter from the filter tubules.

It would be desirable to provide a means of the micro-filtration of water that does not require the removal of the cartridges for cleaning.

It is therefore a first object of the present invention to provide a means to clean the filtration element in situ without removal of the cartridge.

### SUMMARY OF INVENTION

In the present invention, the first object is achieved by providing a multi-way valve and distribution system that allows for flushing in the reverse direction of treatment, which is through the central outlet tube into the tubules.

A second aspect of the invention is characterized in that chemical cleaning agent are introduced into the flushing effluent automatically in a controlled fashion without the need for additional pumps.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a schematic illustration of first embodiment of the submicron filtration system or apparatus.

FIGS. 2A and B illustrate processes of use of the apparatus of FIG. 1 with different valve states.

FIGS. 3A and B illustrate alternative processes of use of the apparatus of FIG. 1 with different valve states.

FIG. 4 illustrates another alternative process of use of the apparatus of FIG. 1 with different valve states.

FIG. 5 A is a top plan view of the adapter 500.

FIG. 5B is an exterior elevation of the adapter 500.

FIG. 5C is a bottom plan view of the adapter 500.

FIG. 6 is a schematic illustration of an alternative embodiment of a micro-filtration system.

FIG. 7A is a top plan view of the plug/coupling used with the valve in FIG. 6.

FIGS. 7B and C illustrate the other orthogonal views of FIG. 7A.

FIG. 7D is a top plan view of the plug/coupling used with the valve in FIG. 8-13. FIGS. 7E and F illustrate the other orthogonal views of FIG. 7D.

FIG. 8 is a schematic illustration of another alternative embodiment of the invention using two filter cartridges in which the first filter is operative while the second cartridge is in a stand-by mode.

FIG. 9 is a schematic illustration of another mode of using the alternative embodiment of the invention of FIG. 8 in which the second filter cartridge is operative while the first cartridge is being cleaned by a backwashing process.

FIG. 10 is a schematic illustration of another mode of using the alternative embodiment of the invention of FIG. 8 in which the second filter cartridge is operative while the first cartridge filter is being cleaned by a process that includes a chemical cleaning agent.

FIG. 11 is a schematic illustration of another mode of using the alternative embodiment of the invention of FIG. 8 in which the second filter cartridge is operative while the first cartridge filter is being cleaned by a rapid rinsing process.

FIG. 12 is a schematic illustration of another mode of using the alternative embodiment of the invention of FIG. 8 in which the second filter cartridge is operative while the first cartridge filter is in stand-by showing the process of refilling or making up the chemical cleaning agent used in FIG. 10.

FIG. 13 is a schematic illustration of another mode of using the alternative embodiment of the invention of FIG. 8 in which the second filter cartridge is operative while the first cartridge filter is in a stand-by mode.

### DETAILED DESCRIPTION

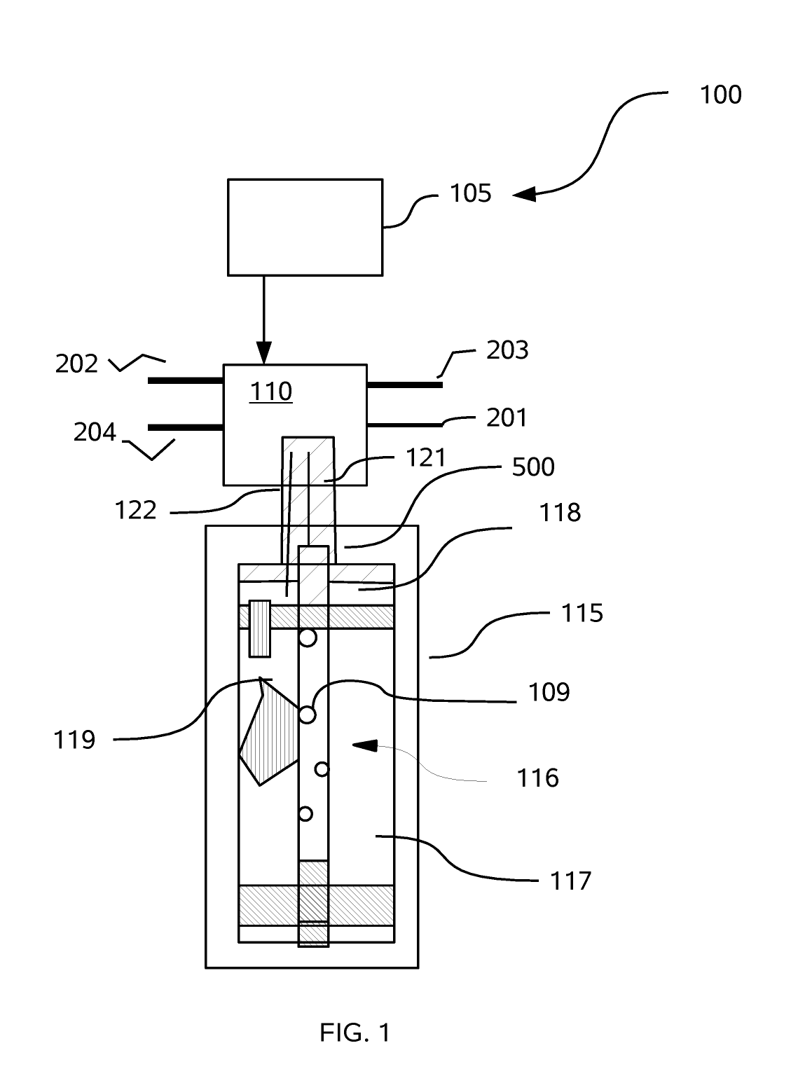

Referring to FIGS. 1 through 13, wherein like reference numerals refer to like components in the various views, there is illustrated therein a new and improved method and apparatus for the purification of water and other fluids by sub-micron filtration and the cleaning/regeneration of associated sub-micron filtration membranes, generally denominated 100 herein.

It should be understood that the term sub-micron filtration is intended to embrace the following terminologies and the attended particle size ranges listed in parenthesis: 1) Microfiltration (0.06-2.00 microns); 2) Ultrafiltration (0.02-0.2 microns); Nanofiltration (0.02-0.002 microns) and the like.

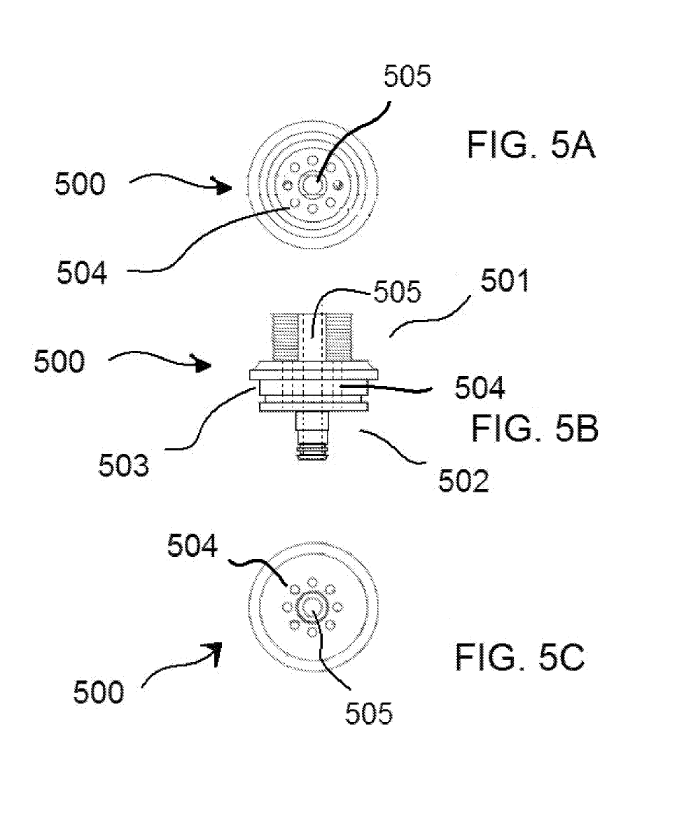

In accordance with the present invention FIG. 1 illustrates the inventive apparatus that comprises a controller 105, multi-directional distribution valve 110, adapter 500 and filtration unit 115. The filtration unit 115 an inlet port 122 and an outlet port 121. Filtration unit 115 has a central tube 116 that is in fluid communication with the space between filtration tubules 119 via holes 109. Filtration tubules 119 are assembled to form a generally removable and replaceable filter cartridge or canister 117. In the normal mode of operation of water purification for “inside-to-outside” flow, water to be purified arrives via inlet port 122 into the head space or sub chamber 118 above the opening to the filtration tubules 119. Purified water passing through the sides of filtration tubules 119 passes into central tube 116 and out of filtration unit 115 via outlet port 121. Adapter 500, shown in FIG. 5 provides the physical connection of source port 201 and product outlet port 202 to the distribution valve 110. The multi-distribution valve 110 has a plurality of portals for inlet of water to be purified source port 201, outlet of purified water or product 202. Inlet 204 provides chemical cleaning agents, whereas port 203 is an outlet drain. It will be understood by one of ordinary skill in the art that the following description while specifically relating to “inside-to-outside” flow, is equally applicable to “outside-to-inside” flow, by reversing the inlet and outlet ports in the following descriptions and figures.

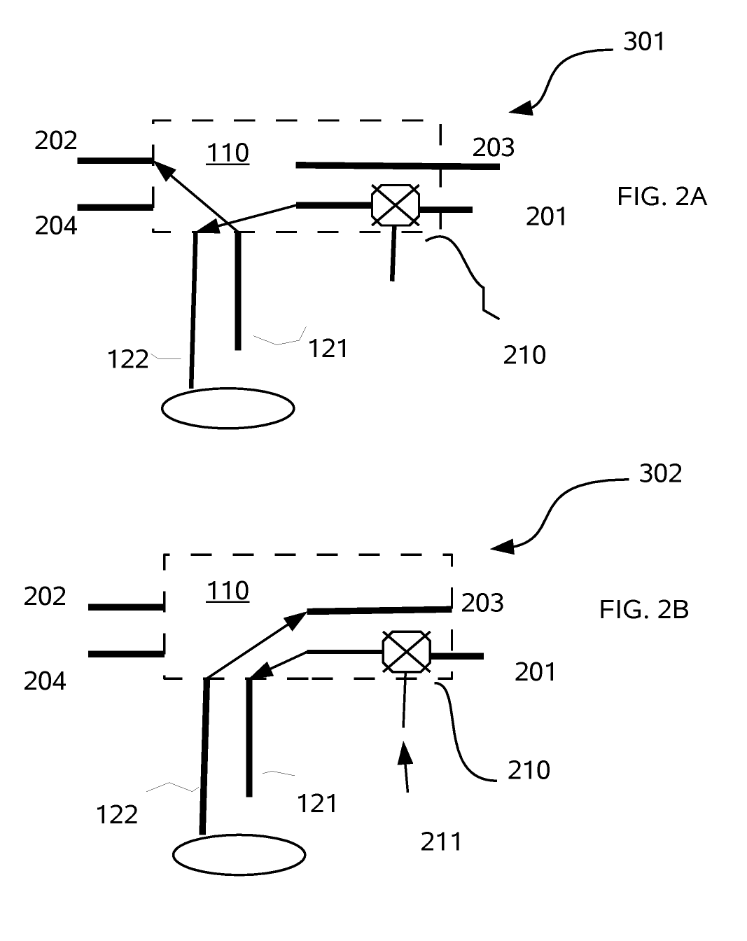

FIG. 2-4 illustrates the states of the valves used in the water purification and regeneration processes. FIG. 2A illustrates the normal operation process 301. In process 301, controller 105 is operative to modulate the position of the valves in multi-distribution valve 110 such that water to be purified is directed by multi-distribution valve 110 from source port 201 to inlet port 122 and when purified from outlet port 121 to product outlet port 202 to be delivered as a product of the process.

A multi-direction distribution valve 110 has a least four ports wherein 2 independent fluid streams flow through the valve at one time and operation of the valve between at least a first and second state redirects the independent fluid stream to alternative ports.

FIG. 2B illustrates a back wash process 302 with treated water. In process 302, controller 105 is operative to modulate the position of the valves in distribution valve 110 such that fluid is directed by distribution valve 110 from source port 201 to outlet port 121 and from inlet port 122 to outlet drain 203. This is deemed the most efficient means to remove debris form the porous wall of tubules 119, as it is the reverse of the flow direction that eventually clogs the tubules. Filtered or treated water can be introduced into outlet port 121 for this cleaning process by turning 3-way valve 210 to admit pure water from a source 211 as shown by the adjacent arrow. It should be noted that the 3-way valve can be part of distribution valve 110, or distribution valve can provide a similar function as is shown in the Figures.

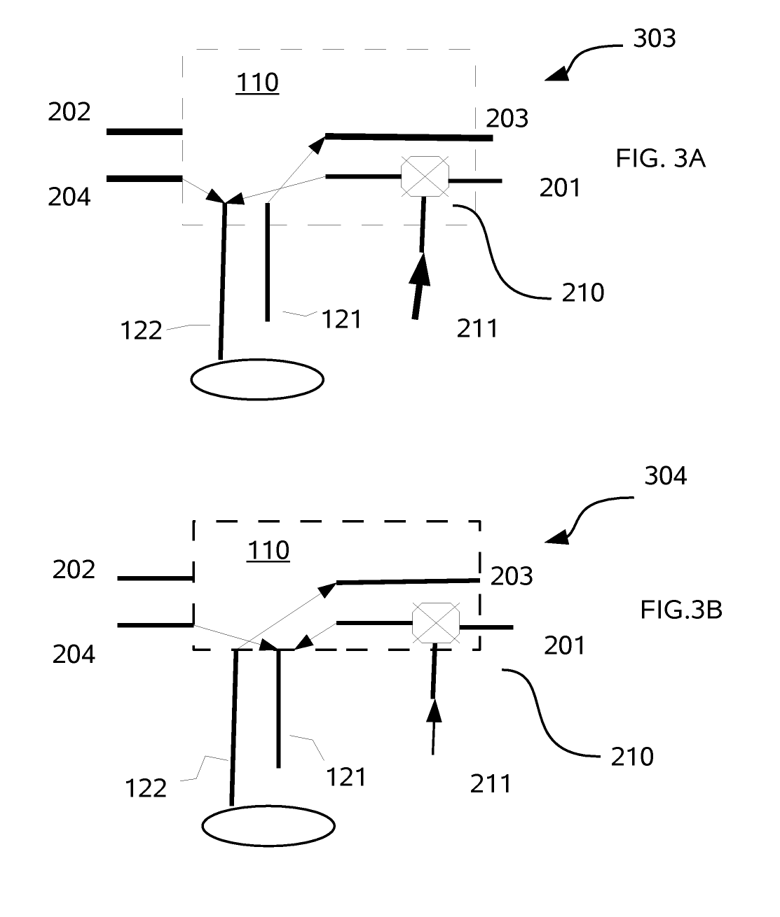

FIG. 3A illustrates a first chemical cleaning process 303. The specific type of cleaning chemicals will in large part depend on the primary nature of the membrane fouling material to be removed, as well as the chemical compatibility of membrane media and other filter components to cleaning chemicals, as is known to those of ordinary skill in the art. Typically such chemical cleaning agent may include without limitation; 1) caustic (NaOH) to increase solubility of solutes by hydrolysis and solubilization, 2) oxidants (such as NaOC₁, H₂O₂, peroxyacetic acid) to oxidize natural organic material (NOM) and increase hydrophilicity by increasing the amount of oxygen containing functional groups such as carboxyl and phenolic groups, 3) acids (such as citric acid or nitric acid) and chelating agents like EDTA for the removal of scale compounds and metal oxides though solubilization and chelating, as well as 4) various proprietary formulations that may use these and other agents in combination, as well as surfactants and detergents.

In process 303, deemed down-flow chemical cleaning, controller 105 is operative to modulate the position of the valves in distribution valve 110 such that fluid is directed by distribution valve 110 from source port 201 to inlet port 122 and from outlet port 121 to outlet drain 203. Thus, chemical cleaning solution is drawn into inlet port 122 from 204 by the Venturi effect.

FIG. 3B illustrates a second chemical cleaning process 304. In process 303, deemed up-flow chemical cleaning, controller 105 is operative to modulate the position of the valves in distribution valve 110 such that fluid is directed by distribution valve 110 from source port 201 to outlet port 121 and from inlet port 122 to outlet drain 203.

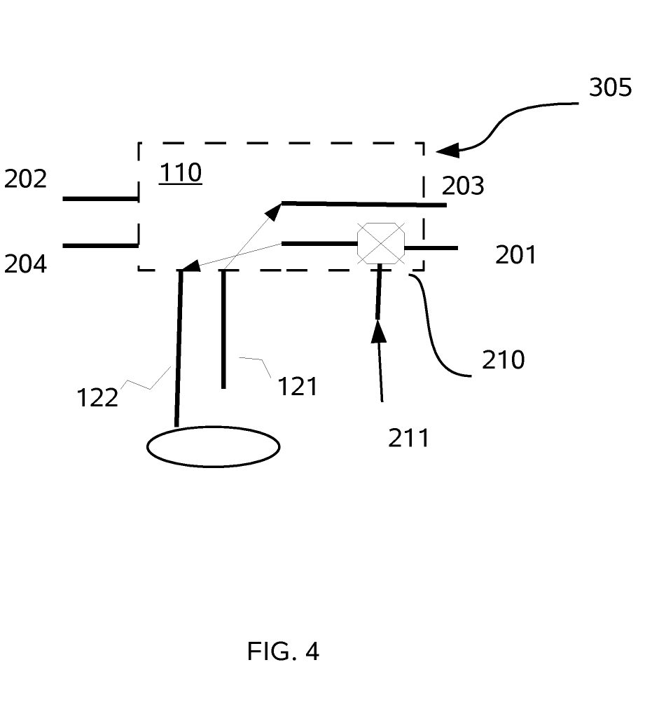

FIG. 4 illustrates rapid cleaning process 305. In process 305, controller 105 is operative to modulate the position of the valves in distribution valve 110 such that fluid is directed by distribution valve 110 from source port 201 to inlet port 122 and from outlet port 121 to outlet drain 203. Thus, filtered/treated water is introduced into source port 201 via valve 210 from source 211, such that is flows first through the tubules in the normal manner in FIG. 2A, however now the effluent from outlet port 121 is directed to the drain.

FIG. 5 illustrates the coupling adapter 500 that connects the distribution valve 110 to filtration unit 115. Coupling adapter 500 has a central circular channel 505 surrounded by a separate co-axial cylinder having a plurality of holes 504 through coupling adapter 500. The upper threaded fitting 501 screws into a conventional control valve distribution valve 110 used in automated water softening equipment, while in contrast the lower neck 502 and the flange 503 are adapted to couple and seal with conventional filtration unit 115. Specifically, lower neck 502 seals the central circular channel 505 with central tube 116 to isolate the fluid communicate from sub chamber 118. Flange 503 seals with filtration unit 115 to provide fluid communication from distribution valve 110 to sub chamber 118 via the plurality of holes 504 in Flange 503.

Thus, the use of adapter 500 with conventional and commercial distribution valve 110, 105 and filtration unit 115 to form device 100 permits cleaning and in particular chemical cleaning automating without removing canister 117 of filtration tubules 119, the controller can be used to automatically clean the filtration tubules 119 on a periodic basis depending on the contaminant and nature of the particulate matter in the water to be treated. Thus, in such a mode process 301 may run for hundreds of hours with cleaning processes 302, 303, 304 and/or 305 periodical running for just a few hours as needed to clean and or rejuvenate filtration tubules 119. Anticipated use/cleaning sequences are 301/302/303 (and/or 304)/305. Alternatively, the sequence 301/302/303 (and/or 304)/302/305 is also anticipated to provide the benefits of increasing the available time for process 301, water purification, with minimum non-productive time in processes 302-305.

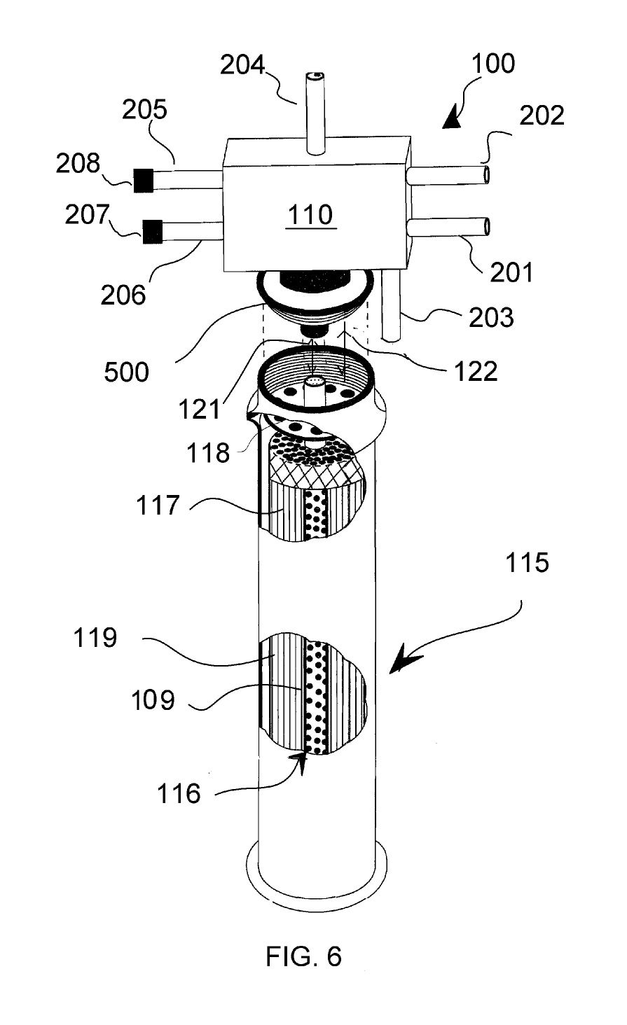

FIG. 6 is a more preferred embodiment of the invention using a Pentair Fleck 9100. The controller 105 (not shown in this figure) is operative to direct fluid in the multiple directions illustrated in FIG. 1-5. Additional ports to valve 110 are covered by plugs 207.

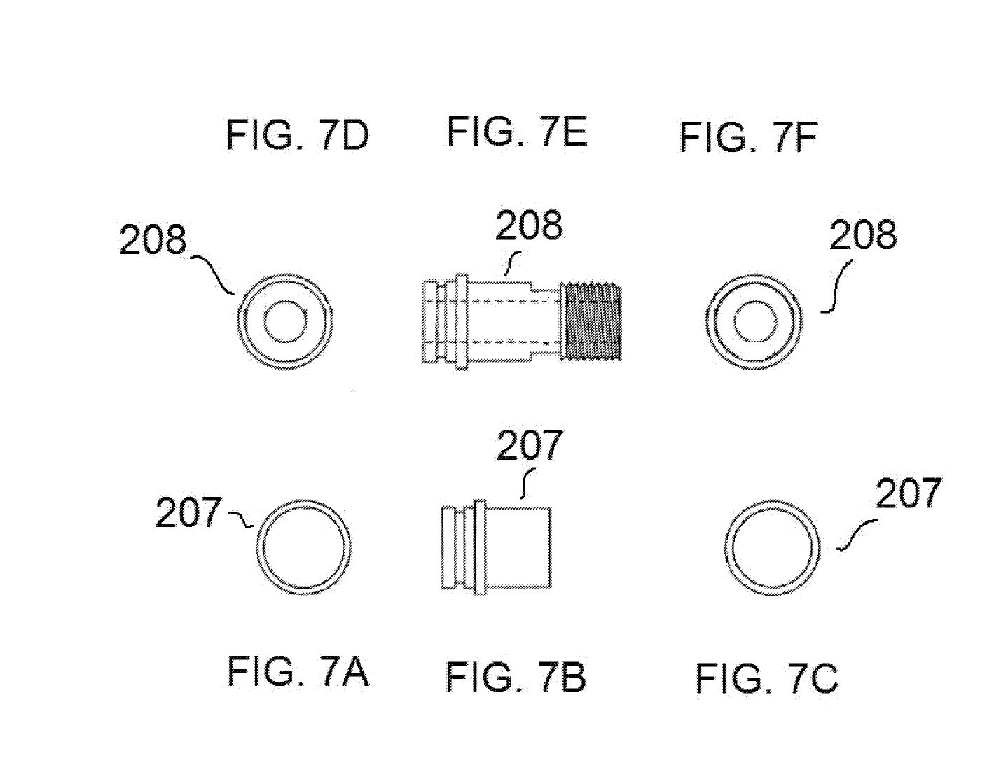

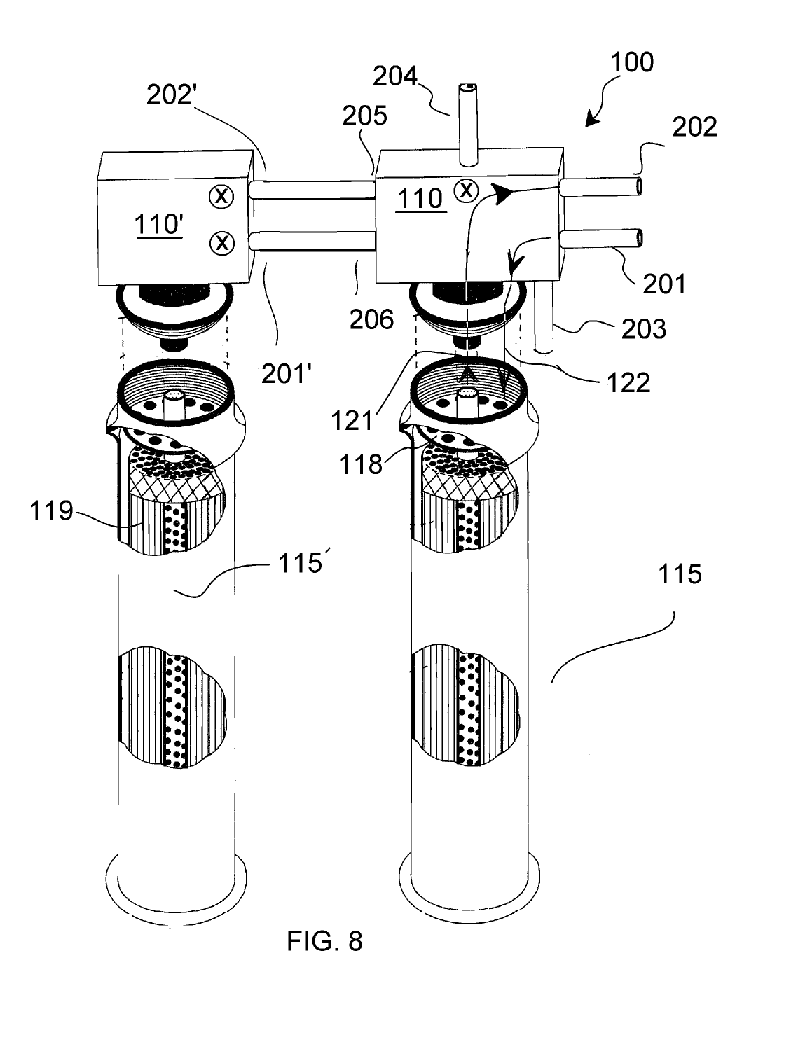

FIG. 7A-C illustrate in orthogonal isometric views plug 207 shown in FIG. 6. FIG. 7D-E illustrate in orthogonal isometric views the threaded adapter 208 used to connect the portal 205 and 206 of the first multi-directional distribution valve 110 to the portal 202′ and 201′ respectively of the second distribution valve 110′, as shown in FIG. 8.

In accordance with another embodiment of the present invention, FIG. 8 is a system configured for continuous operation where one cartridge is always in operation when the other is being cleaned, regenerated or replaced.

As in FIG. 1 and FIG. 6 second filtration unit 115′ has an adapter 500 such that it is in variable fluid communication with distribution valve 110 via a second distribution valve 110′. Distribution valve 110 has a second exit portal 205, and a second inlet portal 206. The exit portal 205 of distribution valve 110 is connected to the inlet portal 201′ of distribution valve 110′. The second inlet portal 206 is connected to the exit portal 202 ‘of the second distribution valve 110′.

In FIG. 8 distribution valve 110 is operative to close portal 205 and 206 so that cartridge 115′ is in a “stand-by” mode, with cartridge 115′ operative in the same fashion as described with respect to previous embodiments, that is raw water enters distribution valve 110 via portal 201 and pure water exits via portal 202.

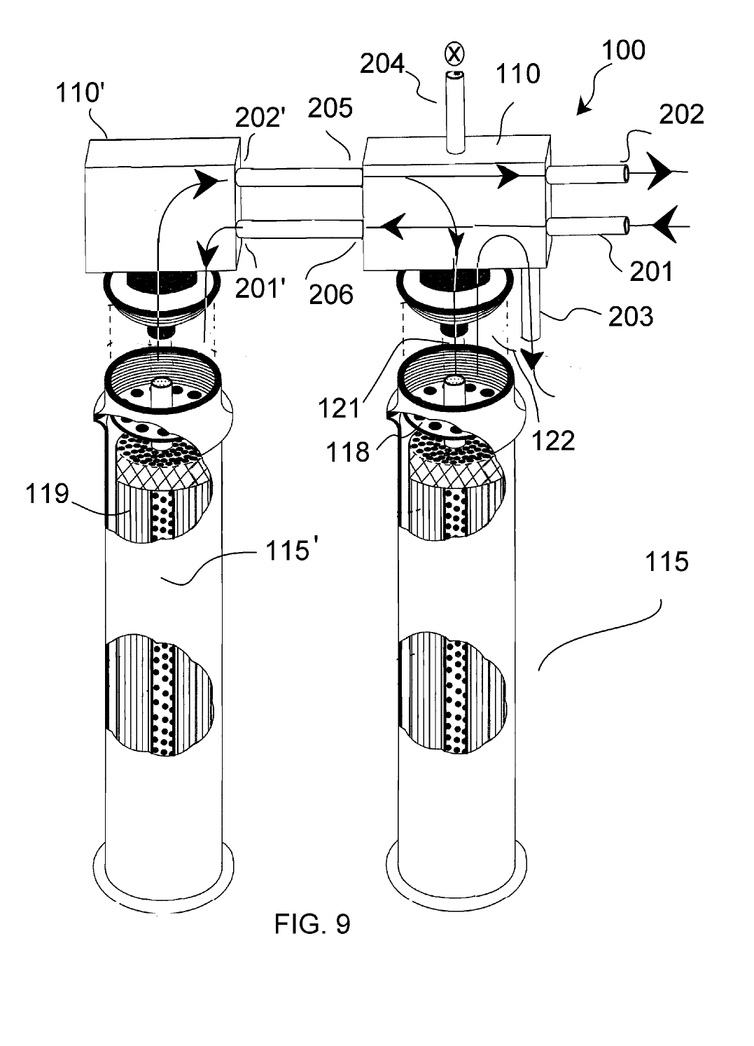

FIG. 9-13 Illustrate alternative modes of using dual filtration unit system of FIG. 8. X shows the conditions when a portal is closed by the distribution valve 110 or 110′ and arrow show the direction of fluid flow between the portals, the cartridges 115 and 115′ and outside connections.

In FIG. 9, cartridge 115′ continuously filters incoming raw water via portal 201′, returning purified water or fluid via portal 202′ to distribution valve 110, via portal 205. Simultaneously cartridge 115 is cleaned by backwashing as distribution valve 110 is operative to direct incoming raw water from portal 201 to 201′, and purified water from portal 202′ to portal 202. However, the distribution valve 110 is also operative to divert a portion of the purified water from portal 205 to outlet port 121, with the backwashed water exiting portal 202 via drain 203.

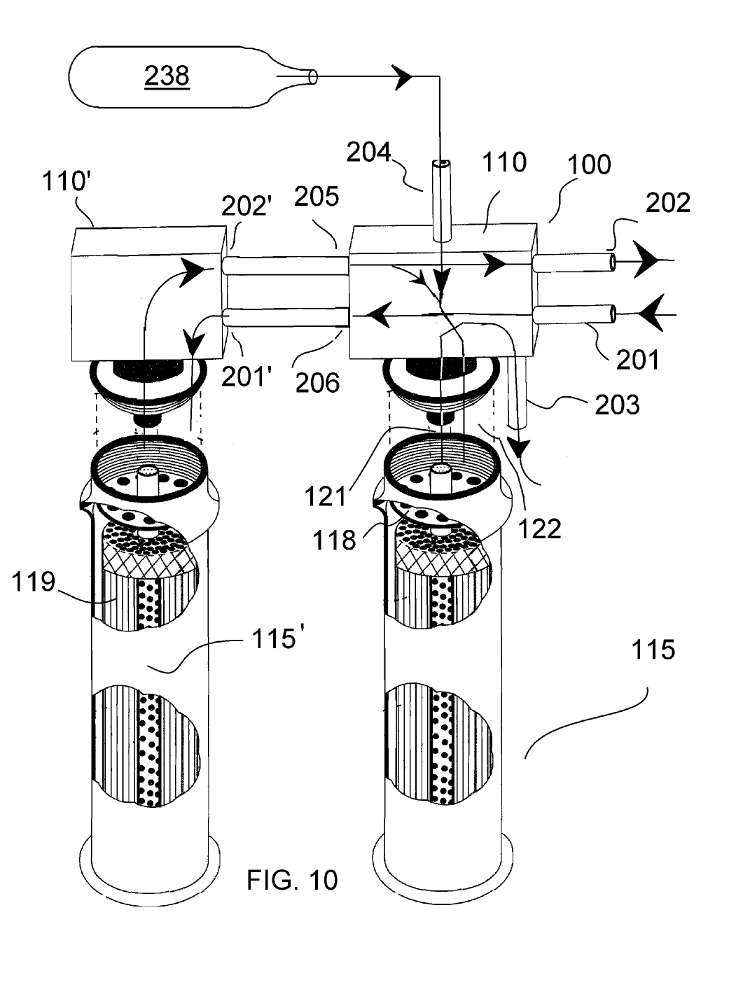

In FIG. 10, chemical cleaning agent is drawn into cartridge 115 from chemical cleaning agent tank 238 while cartridge 115′ is in service. The distribution valve 110 is operative to direct a portion of purified water from portal 205 to outlet port 121, while at the same time opening the connection to the chemical feed tank 238 via portal 204 such that stream of fluid into outlet port 121 downstream of portal 205 draws fluid from the cleaning tank via a Venturi effect into cartridge 115. The fluid exiting cartridge 115 is then diverted by distribution valve 110 to 203.

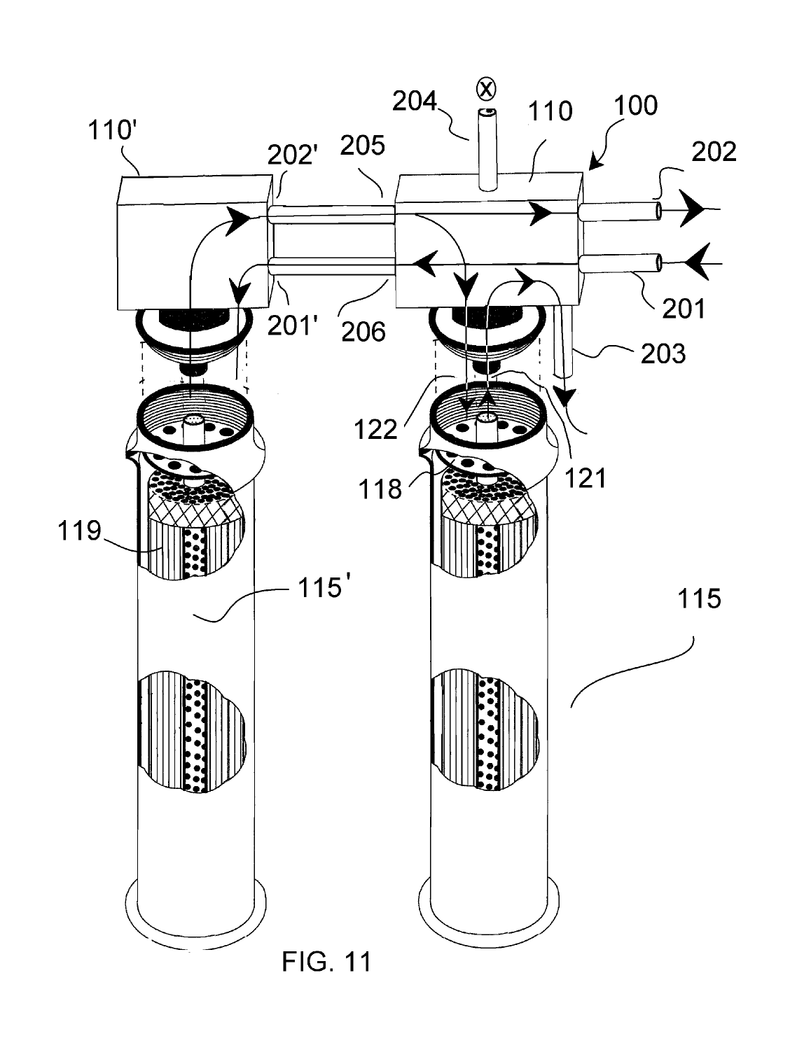

In FIG. 11, cartridge 115, it is rapidly rinsed after chemical cleaning while cartridge 115′ is in service. This is achieved by closing off the flow from portal 204, such that a portion of the purified water flowing from portal 205 to portal 202 is feed into cartridge 115 via inlet port 122.

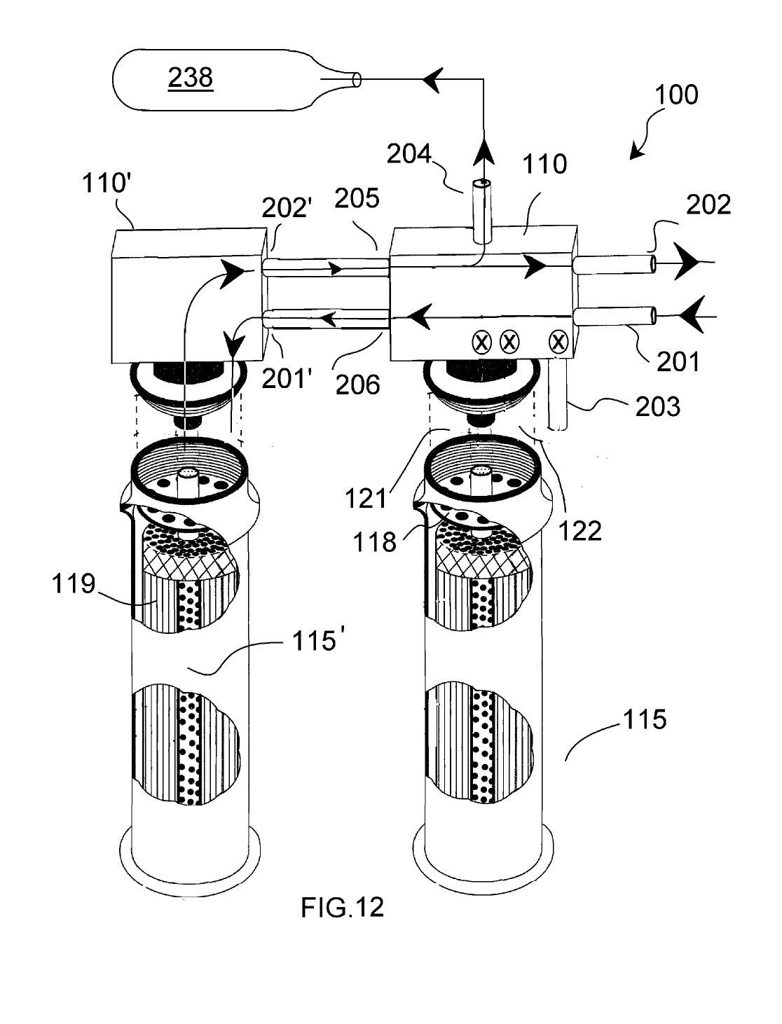

In FIG. 12, the chemical feed tank 238 is partially filled with water to dilute the cleaning solution to its working concentration. A concentrated chemical cleaning solution or solid agent is placed in tank 238 before connection to portal 204.

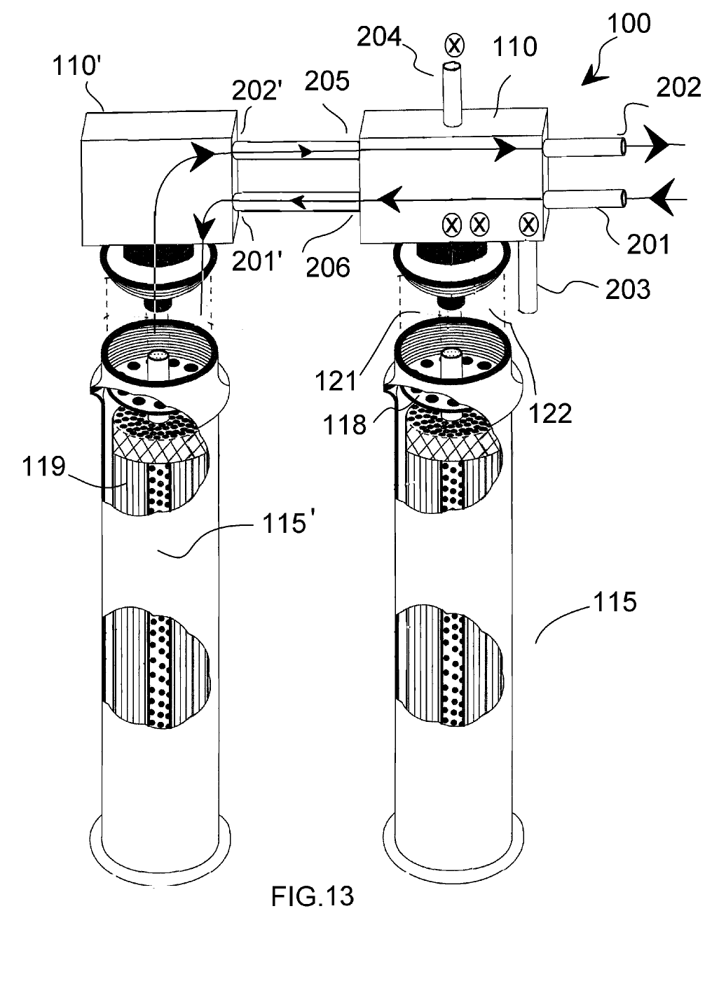

In FIG. 13, cartridge 115′ is operative, while cartridge 115 is in standby mode, having been cleaned by the procedures shown in FIG. 8-12.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A fluid purification device comprising:
a) a multi-directional valve,
b) at least one submicron filtration cartridge with an inlet port connected to direct water to at least one of porous tubules or the space between porous tubules within said cartridge, and an outlet port in fluid communication with water purified by the filtration action of the tubules,
c) a first inlet port in fluid communication with said multi-directional valve for receiving fluid to be filtered by said filter cartridge, and
d) a first outlet port in fluid communication with said multi-directional valve for receiving fluid that has been filtered by said filter cartridge or backwashing said filter cartridge,
e) controller means to open selective ports of said multi-directional valve for directing water into the outlet port for flushing contaminants from the tubules via another port.

2. A fluid purification device according to claim 1 wherein the connection of the a multi-directional valve to the at least one submicron filtration cartridge is by a coupling in which at least one of inlet and outlet port is a circular channel and the other port is a co-axial cylinder surrounding said circular channel.

3. A fluid purification device comprising
a) a multi-directional valve,
b) at least one submicron filtration cartridge with a first inlet port connected to direct water to at least one of porous tubules or the space between porous tubules within said cartridge, and a first outlet port in fluid communication with water purified by the filtration action of the tubules,
c) a first inlet port in fluid communication with said multi-directional valve for receiving fluid to be filtered by said filter cartridge, and
d) a first outlet port in fluid communication with said multi-directional valve for receiving fluid that has been filtered by said filter cartridge or backwashing said filter cartridge,
e) an automated controller,
f) wherein the multi-directional valve is in fluid communication with the at least one submicron filtration cartridge wherein the automated controller is operative to open selective ports of said multi-directional valve for directing water into the outlet port for flushing contaminants from the tubules of said at least one submicron filtration cartridge via another port thereof.

4. A fluid purification device according to claim 1 wherein the connection of the a multi-directional valve to the at least one submicron filtration cartridge is by a coupling in which at least one of inlet and outlet port is a circular channel and the other port is a co-axial cylinder surrounding said circular channel.

5. A fluid purification device according to claim 3 that further comprises,
a) a source of a chemical cleaning agent,
b) and said multi-directional valve further comprises;
i) a port for receiving the chemical cleaning agent from said source in fluid communication therewith, and
ii) a drain port;
c) wherein the controller is operative to direct chemical cleaning agent into the at least one submicron filtration cartridge and thereafter to said drain port.

6. A fluid purification device according to claim 4 that further comprises,
a) a source of a chemical cleaning agent,
b) and said multi-directional valve further comprises;
i) a port for receiving the chemical cleaning agent from said source in fluid communication therewith, and
ii) a drain port;
c) wherein the controller is operative to direct chemical cleaning agent into the at least one submicron filtration cartridge and thereafter to said drain port.

7. A fluid purification device according to claim 6 wherein the multi-directional valve is operative to draw the chemical cleaning agent into the at least one submicron filtration cartridge by Venturi action while diluting said cleaning agent with water received from at least one other port.

8. A fluid purification device according to claim 6 wherein the multi-directional valve is operative to draw water received from at least one other port into the chemical cleaning agent source to dilute the cleaning agent in the source.

9. A fluid purification device according to claim 3 wherein said multi-directional valve further comprises;
a) a second outlet port wherein the controller is operative to direct fluid from the first inlet port thereto,
b) a second inlet port wherein the controller is operative to direct fluid from the second inlet port to the first outlet port.

10. A fluid purification device according to claim 3 and further comprising a second cartridge wherein the controller is operative to selectively purify the fluid in either of said first or second cartridge while cleaning the other cartridge.

11. A fluid purification device according to claim 5 and further comprising a second cartridge wherein the controller is operative to selectively purify the fluid in either of said first or second cartridge while cleaning the other cartridge.

12. A fluid purification device according to claim 6 and further comprising a second cartridge wherein the controller is operative to selectively purify the fluid in either of said first or second cartridge while cleaning the other cartridge.

13. A fluid purification device according to claim 7 and further comprising a second cartridge wherein the controller is operative to selectively purify the fluid in either of said first or second cartridge while cleaning the other cartridge, the second cartridge being in fluid communication with the first inlet port and second outlet port of said multi-directional valve.

14. A process for fluid purification, the process comprising the steps of:
a) providing;
i) a multi-directional valve,
ii) at least one submicron filtration cartridge with a first inlet port connected to direct water to at least one of porous tubules or the space between porous tubules within said cartridge, and a first outlet port in fluid communication with water purified by the filtration action of the tubules,
iii) a first inlet port in fluid communication with said multi-directional valve for receiving fluid to be filtered by said filter cartridge, and
iv) a first outlet port in fluid communication with said multi-directional valve for receiving fluid that has been filtered by said filter cartridge or backwashing said filter cartridge,
v) an automated controller,
vi) wherein the multi-directional valve is in fluid communication with the at least one submicron filtration cartridge wherein the automated controller is operative to open selective ports of said multi-directional valve for directing water into the outlet port for flushing contaminants from the tubules of said at least one submicron filtration cartridge via another port thereof.
b) purifying the fluid periodically by;
i) receiving the fluid to be purified
ii) transmitting the fluid to be purified
c) regenerating the filter cartridge periodically without disconnection from the multi-direction valve by at least one of backwashing and introducing a chemical cleaning process.

15. A process for fluid purification according to claim 14 wherein, the fluid is water.

16. A process for fluid purification according to claim 15 wherein the fluid is water and the chemical cleaning agent is selected from the group consisting of caustic, oxidants, acids, chelating agents, surfactants and detergents.

17. A process for fluid purification according to claim 14 wherein the process further comprises the steps of providing a second submicron filtration cartridge and at least one of the steps of regenerating the first or second filter cartridge while the other cartridges filters fluid.

18. A process for fluid purification according to claim 17 wherein the fluid is water and the chemical cleaning agent is selected from the group consisting of caustic, oxidants, acids, chelating agents, surfactants and detergents.
